(19) United States
(12) Patent Application Publication
(10) Pub. No.: US 2005/0265164 A1
(43) Pub. Date: Dec. 1, 2005

(54) Recording and reproducing apparatus and recording and reproducing method

(75) Inventor: Naozumi Koshino, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/138,904

(22) Filed: May 27, 2005

(30) Foreign Application Priority Data
May 31, 2004 (JP) 2004-161425

(51) Int. Cl. G11B 5/09

(52) U.S. Cl. 369/47.1; 369/59.1

(57) ABSTRACT

A recording and reproducing apparatus comprises a communication section which acquires content information from an external device via a network, a recording section which records in a storage region the content information, and a control section which, after it has been detected that the content information stored in the recording section cannot be read out, when it is determined that the content information cannot be reacquired from the external device due to an occurrence of a failure with a function of the communication section or recording section, controls a command signal for causing a terminal device over a network to substitute reacquisition of the content information from the terminal device so as to be transmitted to the terminal device.

### CROSS-REFERENCE TO RELATED APPLICATIONS

This application is based upon and claims the benefit of priority from prior Japanese Patent Application No. 2004-161425, filed May 31, 2004, the entire contents of which are incorporated herein by reference.

### BACKGROUND OF THE INVENTION

1. Field of the Invention

The present invention relates to a recording and reproducing apparatus for acquiring content information via a network and recording and reproducing the acquired content information. More particularly, the invention relates to a recording and reproducing apparatus and a recording and a reproducing method which cause another recording and reproducing apparatus over a network to substitute reacquisition (restoring) of content information if the content information is destroyed and cannot be reacquired.

2. Description of the Related Art

With the recent prevalence of a high speed and broadband network such as the ADSL and CATV Internet and the establishment of a connection standard for a household digital device, there is a growing need for a recording and reproducing apparatus in which a user can enjoy copyright reserved content distributed via the Internet from any device if it is capable of carrying out a reproducing operation, without worrying about the storage device.

However, in the recording and reproducing apparatus, the content are often stored on a fixed disk incorporated in a digital device with its durability and reliability which are inferior to an optical disk such as DVD-ROM or CD-ROM. Therefore, there is a case in which the content is erased or destroyed due to degradation with an elapse of time or a user's operational error, and the erased or destroyed content cannot be read.

In Patent Document 1 (Jpn. Pat. Appln. KOKAI Publication No. 2001-195509), there is disclosed a method for separately storing backup data in a fixed disk, and, if content is destroyed, reproducing the backup data to referring to a use log.

In addition, in Patent Document 2 (Jpn. Pat. Appln. KOKAI Publication No. 2002-334173), there is disclosed a method for a terminal having received content distribution to hold an electronic receipt distributed from a server, and then, transmit the electronic receipt to the server during a request for redistribution of content, thereby efficiently using a content redistribution process.

However, in the above-described prior art, an available disk space becomes short because the backup data on content information is maintained in the fixed disk incorporated in the recording and reproducing apparatus. In addition, in the case where the fixed disk has failed, even if one requests the server to redistribute the content, there is a problem that re-downloading cannot be carried out because a storage destination itself does not exist.

### BRIEF SUMMARY OF THE INVENTION

A recording and reproducing apparatus according to an embodiment of the present invention comprises: a communication section which acquires content information from an external device via a network; a recording section which records in a storage region the content information acquired from the communication section; and a control section which, after it has been detected that the content information stored in the recording section cannot be read out, when it is determined that the content information cannot be reacquired from the external device due to an occurrence of a failure with a function of the communication section or recording section, controls a command signal for causing a terminal device over a network to substitute acquisition of the content information so as to be transmitted to the terminal device via the communication section.

### BRIEF DESCRIPTION OF THE SEVERAL VIEWS OF THE DRAWING

FIG. 1 is a block diagram depicting an example of a configuration of a recording and reproducing apparatus according to one embodiment of the present invention;

FIG. 2 is a system diagram depicting transmission/reception of signals, of the recording and reproducing apparatus according to one embodiment of the present invention, to/from a server over a network;

FIG. 3 is a system diagram depicting transmission/reception of signals, of the recording and reproducing apparatus according to one embodiment of the present invention, to/from the server over the network;

FIG. 4 is a flowchart showing an operation of a first embodiment of the recording and reproducing apparatus according to the present invention;

FIG. 5 is a flowchart showing an operation of a second embodiment of the recording and reproducing apparatus according to the present invention; and

FIG. 6 is a flowchart showing an operation of a third embodiment of the recording and reproducing apparatus according to the present invention.

### DETAILED DESCRIPTION OF THE INVENTION

Hereinafter, embodiments of the present invention will be described with reference to the accompanying drawings.

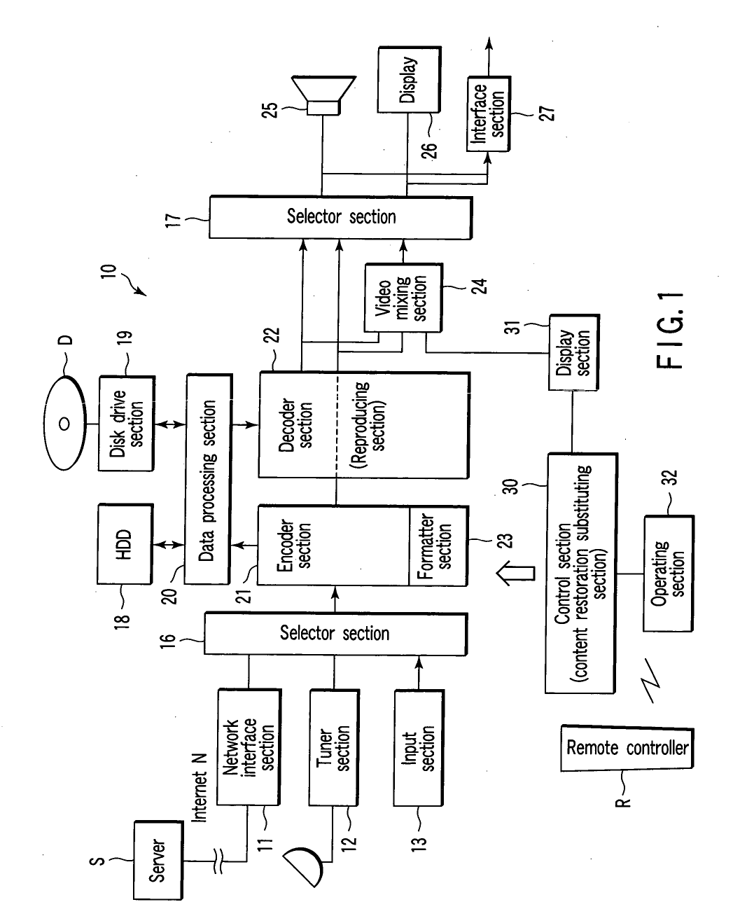

A recording and reproducing apparatus according to the present invention will be described below in detail by way of example of a hard disk recorder 10 having a communication function and the like as shown in FIG. 1.

### RECORDING AND REPRODUCING APPARATUS ACCORDING TO ONE EMBODIMENT OF THE PRESENT INVENTION

First, a configuration of the recording and reproducing apparatus according to the present invention will be described with reference to the accompanying drawings. FIG. 1 is a block diagram depicting an example of a configuration of a recording and reproducing apparatus according to one embodiment of the present invention.

(Configuration)

Although the present embodiment presents that a recording and reproducing apparatus 10 is provided as an apparatus which can handle both a DVD-RAM and a hard disk as a recording medium, the hard disk or DVD-RAM may be replaced with, for example, a recording medium using a semiconductor memory. The blocks of FIG. 1 are roughly divided into a main block of a recording section shown on the left side and a main block of a reproducing section shown at the right side.

The recording and reproducing apparatus 10 of FIG. 1 has two types of disk drive sections. This apparatus has a disk drive section 19 which executes readout and writing of information by rotationally driving an optical disk D as a first medium which is an information recording medium capable of constructing a video file. Also, the apparatus has a hard disk drive section 18 which drives a hard disk as a second medium. A control section 30 can supply recorded data to the disk drive section 19 and the hard disk drive section 18 and can receive a reproduced signal. The disk drive section 19 has a rotation control system, a laser drive system, an optical system and the like for the optical disk D.

The control section 30 handles data in units of recording or reproduction, and includes a buffer circuit, a modulator and demodulator circuit, an error correcting section, and the like. The control section also has a control section for substituting restoring of content information which is described later in detail.

The recording and reproducing apparatus 10 of FIG. 1 primarily comprises: an encoder section 21 configuring an image recording side; a decoder section 22 configuring a reproduction side; and the control section 30 which controls an operation of an apparatus main body.

The recording and reproducing apparatus 10 has, as an input side, for example, a network Interface section 11 for making connection to a server S or the like via the Internet or the like and downloading content information or the like; a tuner section 12 which channel-selects and demodulates a broadcast signal via an antenna and outputs a picture signal and a voice signal; and an input section 13 for receiving a luminance signal and a color difference signal, a picture signal such as a composite signal, or a voice signal. These elements are selectively supplied to the encoder section 21 after an input has been controlled by a selector 16 controlled by the control section 30 or the like. That is, to the encoder section 21, an external analog video signal or an external analog audio signal from the input section 13 or an analog video signal and an analog audio signal from the TV tuner 12 are inputted via the selector 16.

The encoder section 21 has: a video and audio analog digital converter for digitizing an analog video signal or an analog audio signal inputted by the selector 16; a video encoder; and an audio encoder. The encoder section further includes a subsidiary picture encoder.

An output of the encoder section 21 is converted to a predetermined DVD-RAM format by means of a formatter section 23 including a buffer memory, and the converted output is supplied to the control section 30 described previously.

When the compressed digital video signal or digital audio signal is directly inputted, the encoder section 21 can supply the compressed digital video signal or digital audio signal directly to the formatter section 23. Further, the encoder section 21 can supply the analogously or digitally converted digital video signal or audio signal directly to a video mixing section 24 or a selector section 17.

In the video encoder included in the encoder section 21, a digital video signal is converted to a digital video signal compressed at a variable bit rate in accordance with an MPEG2 or MPEG1 standard. A digital audio signal is converted to a digital audio signal compressed at a fixed bit rate in accordance with an MPEG or AC-3 standard or a linear PCM digital audio signal.

In the case where a subsidiary picture signal (such as a signal from a DVD video player with an independent output terminal of a subsidiary picture signal) has been inputted from the input section 13 or in the case where a DVD video signal having such a data structure has been broadcast, and then, the broadcast video signal has been received by the TV tuner 12, the subsidiary picture signal included in the DVD video signal is encoded (run length encoded) by means of the subsidiary picture encoder, and a subsidiary picture bitmap is produced.

The encoded digital video signal, digital audio signal, and subsidiary picture data are packed at the formatter section 23, and the packed signals and data are produced as a video pack, an audio pack, and a subsidiary picture pack. These packs are further collected and converted to a format defined in accordance with a DVD-recording standard (standard to be recorded in DVD-RAM, DVD-R, DVD-RW or the like, for example).

The apparatus of FIG. 1 can supply the information formatted by the formatter section 23 (video, audio, and subsidiary picture data packs) and the produced management information to the hard disk drive section 18 or the data disk drive section 19 via the control section 30 and can record these items of information in the hard disk section 18 or the optical disk D. Furthermore, the information recorded in the hard disk section 18 or optical disk D can be recorded in the optical disk D or hard disk via the disk drive section 19.

Moreover, an editing process such as partially deleting video objects of a plurality of programs recorded in the hard disk or optical disk D or connecting objects of different programs with each other can be carried out.

The control section 30 includes: a micro-processing unit (MPU) or a central processing unit (CPU); a ROM having a control program or the like written therein; and a RAM for providing a work area required for executing a program.

The MPU of the control section 30 can determine a readout or write address in the hard disk drive section 18 by using the RAM as a work area and can provide fault location detection, unrecorded region detection, image recording information recording position setting, UDF recording, AD address setting and the like. The control section 30 also has a function of controlling a process for substituting restoring of content information described later in detail.

In addition, the control section 30 has an information processing section required for controlling a whole system and has the above-described work RAM. Further, according to another embodiment, it is preferable that this control section comprises: in addition to a directory detecting section, and a management information control section during editing and during image recording, which are not shown, a VMG (whole video management information) information producing section; a copy related information sensing section; a copy and scrambling information processing section (RDI processing section); a packet header processing section; a sequence header processing section; an aspect ratio information processing section and the like.

Among the MPU execution results, the content which should be notified to a user are displayed on a display section 31 of the recording and reproducing apparatus or may be on-screen displayed (OSD) on a display 26. The control section 30 also has an operating section 32 which supplies an operating signal for operating this device. It is preferable that the operating section 32 be equipped with a remote controller R.

The adjustment of a timing for the control section 30 to control the disk drive section 19, the hard disk drive section 18, the control section 30, the encoder section 21, and/or the decoder section 22 can be executed based on time data from a system time clock (hereinafter referred to as STC) which is not shown. Although an image recording or reproducing operation is executed in synchronism with a time clock from the STC in general, the other process may be executed at a timing which is independent from the STC.

The decoder section 22 has: a separator which separates and takes out each pack from a DVD format signal having a pack structure; a memory used during pack separation or during execution of other signal processing; a V decoder which decodes main picture data separated by the separator (the content of a video pack); an SP decoder which decodes subsidiary picture data separated by the separator (the content of a subsidiary picture pack); and an A decoder which decodes audio data separated by the separator (the content of an audio pack). In addition, this decoder section comprises a video processor which properly combines the decoded subsidiary picture with the decoded main picture and outputs a menu, a highlight button, a subtitle or any other subsidiary picture to be superimposed on the main picture.

An output video signal of the decoder section 22 is inputted to the video mixing section 24. The video mixing section 24 combines text data. In addition, the video mixing section 24 is connected with a line for directly capturing a signal from the TV tuner 12 or input section 13. A frame memory (not shown) used as a buffer is also connected to the video mixing section 24. When an output of the video mixing section 24 is supplied to the selector 17, and then, the selector section 17 selects the supplied output, the selected output is supplied to be displayed on the display 26 or is supplied to an external device via an interface (I/F) section 27.

An output audio signal of the decoder section 22 is supplied to a speaker 25 after analogously converted by a digital analog converter (not shown) via the selector 17 or is supplied to an external device via the I/F section 27. The selector 17 is controlled by a select signal from the control section 30. In this manner, the selector section 17 enables direct selection of a signal having passed through the encoder section 21 when the selector directly monitors a digital signal from the TV tuner 12 or the input section 13.

The formatter section 23 of the encoder section 21 produces each item of isolation information during image recording, and periodically sends the produced information (information such as time of GOP head interruption) to the MPU of the control section 30. The isolation information includes: the number of VOBU packs; an I-picture end address from the head of VOBU; and a VOBU reproduction time.

At the same time, the information from the aspect information processing section is sent to the MPU when image recording starts, and the MPU produces VOBU stream information (STI). Here, the STI stores resolution data, aspect data and the like, and each decoder section provides initial settings based on this information during reproduction.

The control section 30 receives data in units of VOBI from the formatter section 23 of the encoder section 21, and supplies the data to the disk drive section 19 or the hard disk drive section 18. When the MPU of the control section 30 produces management information required for reproducing recorded data, and recognizes a command indicating the end of data recording, the MPU sends the produced management information to the control section 30. In this manner, the management information is recorded in a disk. Therefore, when encoding is carried out, the MPU of the control section 30 receives information in units of data (such as isolation information) from the encoder section 21. The MPU of the control section 30 recognizes management information (file system) read from the optical disk and hard disk when recording starts; recognizes an unrecorded area of each disk; and sets a data recording area in the disk via the control section 30.

Furthermore, for example, the control section 30 can provide an access to a server for content information provided over the Internet via the network I/F section 11, download the content information, and record the downloaded information in a storage region of the HDD 18, as described later. In addition, the content information recorded in the storage region of the HDD 18 is read from the HDD 18 according to the user's operation, and the read out information is decoded by the decoder section 22. Then, the decoded information is properly selected by the selector section 17 via the video mixing section 24, and the thus selected information is supplied to an external device via the speaker section 25 and the display 26 or I/F section 27.

### PROCESS FOR SUBSTITUTING RESTORATION OF CONTENT INFORMATION ACCORDING TO FIRST EMBODIMENT OF THE PRESENT INVENTION

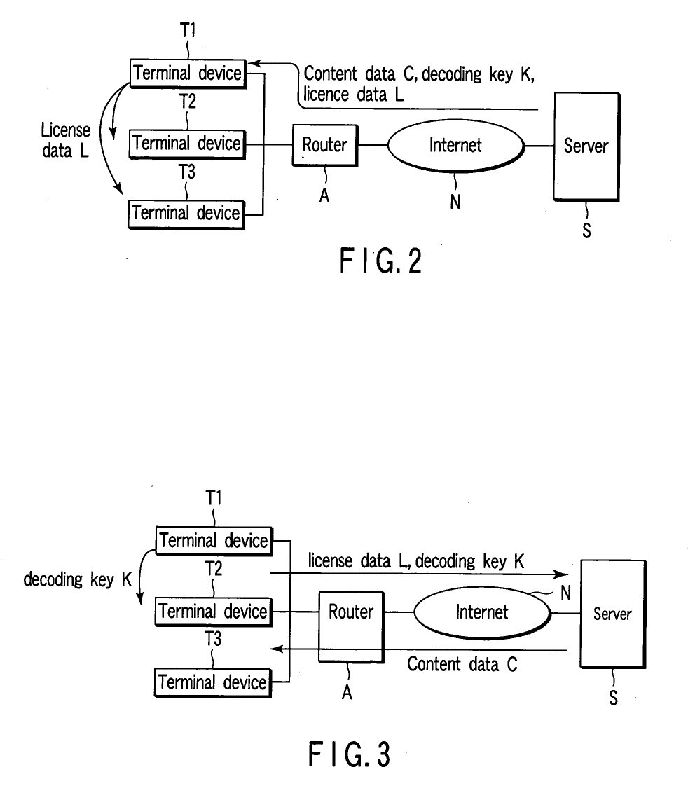

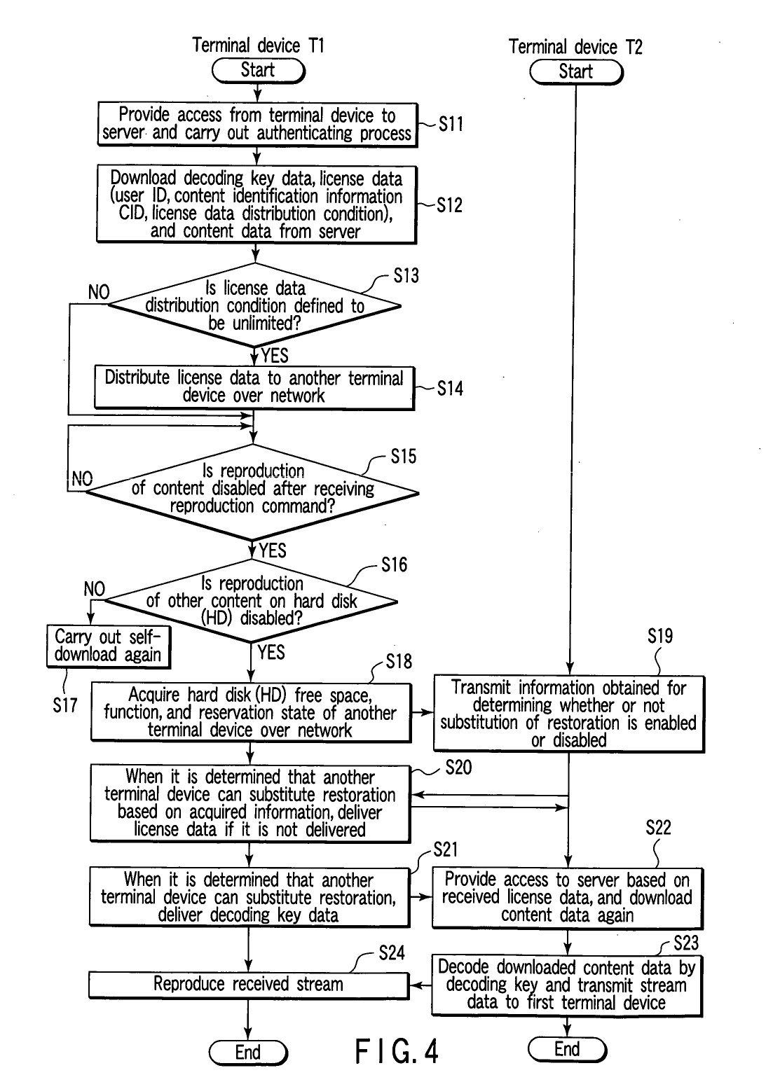

A first embodiment of the present invention specifies a recording and reproducing apparatus which causes a terminal device over a network to substitute restoration of content information in the case where the content information cannot be restored by the apparatus itself. Hereinafter, features of the apparatus will be described with reference to the accompanying drawings. FIG. 2 is a system diagram depicting transmission/reception of signals, of the recording and reproducing apparatus according to one embodiment of the present invention, to/from the server over the network; FIG. 3 is a system diagram depicting transmission/reception of signals, of the recording and reproducing apparatus according to one embodiment of the present invention, to/from the server over the network; and FIG. 4 is a flowchart showing an operation of the first embodiment of the recording and reproducing apparatus according to the invention.

The recording and reproducing apparatus 10 according to one embodiment of the invention causes the terminal device over the network such as LAN at home to substitute restoration of the content information which cannot be restored by the apparatus itself. Now, the recording and reproducing apparatus 10 is a terminal device T1, as shown in FIG. 2, and is connected to be accessible to a server S through the Internet N via a router A. In such a connection state, the recording and reproducing apparatus 10 provides an access from the terminal device T1 to the server S, as shown in the flowchart of FIG. 4, by an operation of a program stored in a ROM or the like (not shown) of the control section 30 shown in FIG. 1, and first supplies a user ID or the like to the server S, thereby carrying out an authenticating process (S11). Then, when authentication is successful, the recording and reproducing apparatus 10 makes a request for providing content information. As shown in FIG. 2, the apparatus downloads decoding key data K, license data L (combination of user ID, content identification information CID, and license data distribution condition), and content information C from the server S via the network Interface section 11 (S12). The content information C is properly formatted by the formatter section 23, and the formatted information is stored in the hard disk drive section 18. In addition, it is preferable that these items of decoding key data K, license data L and the like be stored in a storage region with its high reliability such as a flash ROM. At this time, if the license data distribution condition is defined to be unlimited (S13), the license data is distributed to terminal devices T2, T3 over the network (S14). If a certain limitation is applied, the license data may be distributed later or it is preferable that the data be distributed based on the determination by the control section 30 within the range of this limitation.

Let us consider a case in which, after this downloading has completed, another process such as turning off the power of the recording and reproducing apparatus 10, and then, turning ON the power again may be carried out or may exist, and the user has operated reproduction of the content information after downloading irrespective of a period. Upon the receipt of the user's operation of content information, when the content information cannot be reproduced (S15), it is determined whether or not another item of content information on the hard disk drive section 18 can be reproduced (S16). This denotes that there is a possibility that content information cannot be restored by the apparatus itself because, if such another item of content information cannot be reproduced, there is a possibility that the hard disk drive section 18 in itself is destroyed. At this time, there may be asking a question as to whether or not a failure occurs with a function of making communication with the server S through the Internet N via the router A.

If there occurs no problem with a recording function of the hard disk drive section 18 and a communication function of the network interface section 11 with the internet or the like, the content information is downloaded in accordance with the procedures of step S12 again in order to restore the content information by the recording and reproducing apparatus 10 itself (S17).

If there occurs a problem with a recording function of the hard disk drive section 18 or a function of making communication with the Internet or the like of the network Interface section 11, a request signal for requesting transmission of information is transmitted to each of the terminal devices T2, T3, in order to cause the other terminal devices T2, T3 over the local network to substitute restoration of the content information and in order to collect information on free space and functions or reservation state of a hard disk section of such another terminal device (S18).

In response to this transmission, the terminal device T2 or the like over the local network transmits information required for determining whether or not to substitute restoration, for example, information on a hard disk free space, a communication function, a recording function, and a reservation image recording function (S19). Upon the receipt of these items of information, when it is determined that another terminal device can substitute restoration based on the collected information, the recording and reproducing apparatus 10 delivers license data L to the terminal devices T2, T3, if it has not been delivered yet (S20). Further, when it is determined that another terminal device can substitute restoration, it is preferable that decoding key data K be delivered and decoding key data K stored in the flash ROM or the like be deleted (S21). In this manner, copyright protection of the content information C can be made reliable.

In contrast, the terminal device T2 or the like over the local network provides an access to the server S by delivering the received decoding key data K and license data L, as shown in FIG. 3. When authentication is successful based on the decoding key data K and license data L, the server S supplies the content information C to the terminal device T2 again. The terminal device T2 downloads the content information C (S22), and records the downloaded information in a storage region or the like of a hard disk or the like. Then, the terminal device T2 or the like decodes the downloaded content information based on the decoding key data K, and transmits this stream to the first terminal device T1 (S23). The recording and reproducing apparatus 10 which is the first terminal device T1 reproduces this received streaming (S24), thereby making it possible to utilize the terminal devices T2, T3 over the local area network to substitute restoration of content information, even if a failure occurs with one's own communication function or recording function.

The terminal device utilized here is not limited to that over the local area network. For example, it is preferable that a company's terminal device be utilized to be substituted by a terminal at home via the Internet.

Basically, the other terminal devices T2, T3 over the local area network may have a structure of the recording and reproducing apparatus 10 of FIG. 1. It is desirable that the recording and reproducing apparatus 10 have both of a function of substituting restoration of content information and a function of causing any other device to substitute restoration. It is preferable that these functions be provided as a program stored in the storage region such as the ROM (not shown) of the control section 30. These terminal devices each have functions shown in the flowchart of the terminal device T1 and the flowchart of the terminal device T2, of FIG. 4.

### PROCESS FOR SUBSTITUTING RESTORATION OF CONTENT INFORMATION ACCORDING TO SECOND EMBODIMENT OF THE PRESENT INVENTION

A second embodiment of the present invention specifies both of a case of, when content information has been restored by another terminal device, reproducing the restored content information by one's own terminal device and a case of reproducing the content information by such another terminal device.

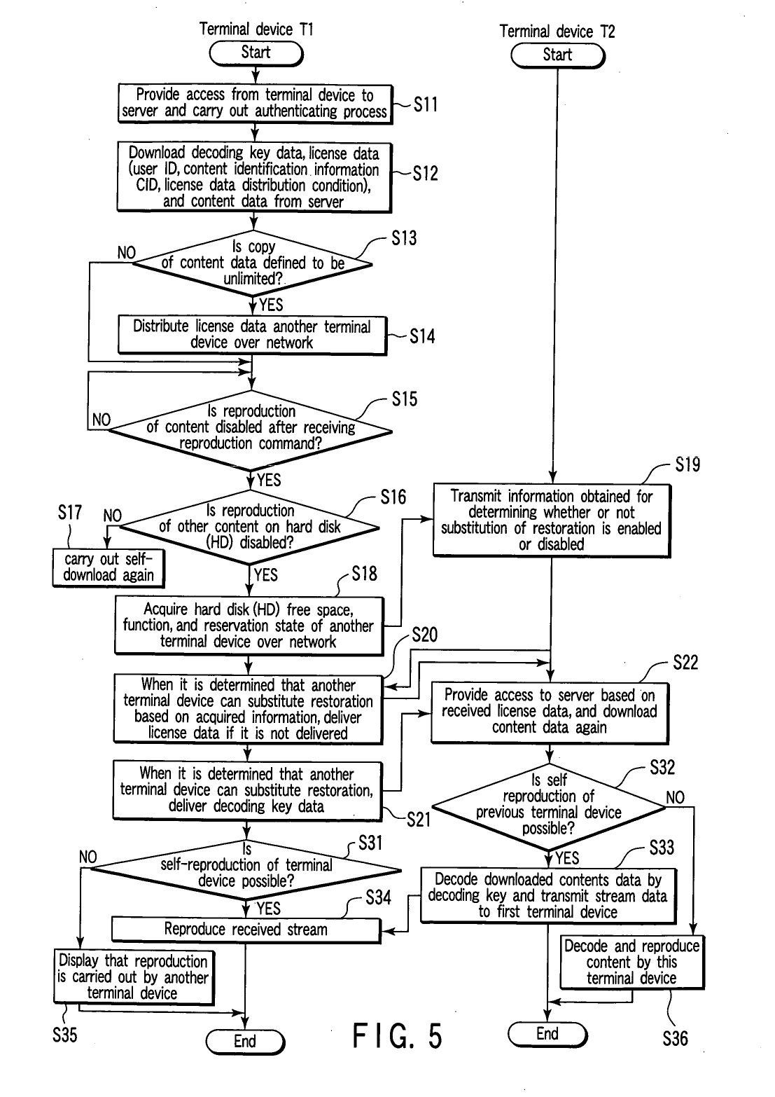

That is, in the recording and reproducing apparatus 109 according to one embodiment of the invention, as shown in the flowchart of FIG. 5, in step S11 to step S22, restoration of content information is carried out by another terminal device over the local area network in accordance with the procedures similar to those shown in the flowchart of FIG. 4.

When it is determined that another terminal device can substitute restoration, decoding key data K is delivered and decoding key data K on a flash ROM or the like is deleted (S21). In response to this process, the terminal device T2 or the like over the local network provides an access to the server S based on the received license data to download content information C again (S22). At this time, in the case where the recording and reproducing apparatus 10 which is the terminal device T1 has a reproduction function of each of the decoder section and reproducing section 22 by itself (S31), this apparatus reproduces the streaming received from the another terminal device T2 by itself (S34). In the case where the recording and reproducing apparatus 10 being the terminal device T1 does not have a reproduction function of each of the decoder section and reproducing section 22 by itself (S35), the fact that content information is reproduced by the another terminal device T2 or the like is displayed on, for example, the display 26 or display section 31 so as to be notified to the user (S35).

On the other hand, in the another terminal device T2 as well, in the case where the terminal device has a reproduction function of the terminal device T1 (S32), the another terminal T2 decodes the downloaded content information based on the decoding key data K, and transmits this streaming to the terminal device T1 (S33). In addition, in the case where the recording and reproducing apparatus 10 which is the terminal device T1 does not have a reproduction function of each the decoder section and reproducing section 22 by itself, this terminal device T2 decodes content information and reproduces the content information based on this streaming (S36).

In this manner, the recording and reproducing apparatus 20 in itself can reproduce streaming or can cause another terminal device to carry out reproduction according to a state of the reproduction function of the recording and reproducing apparatus 20.

### PROCESS FOR SUBSTITUTING RESTORATION OF CONTENT INFORMATION ACCORDING TO THIRD EMBODIMENT OF THE PRESENT INVENTION

A third embodiment of the present invention, unlike the first and second embodiments, specifies that a timing of detecting content information in a recording region of a recording and reproducing apparatus is defined as a time point at which the recording and reproducing apparatus has been powered ON, instead of defining a time point when a reproduction command is issued.

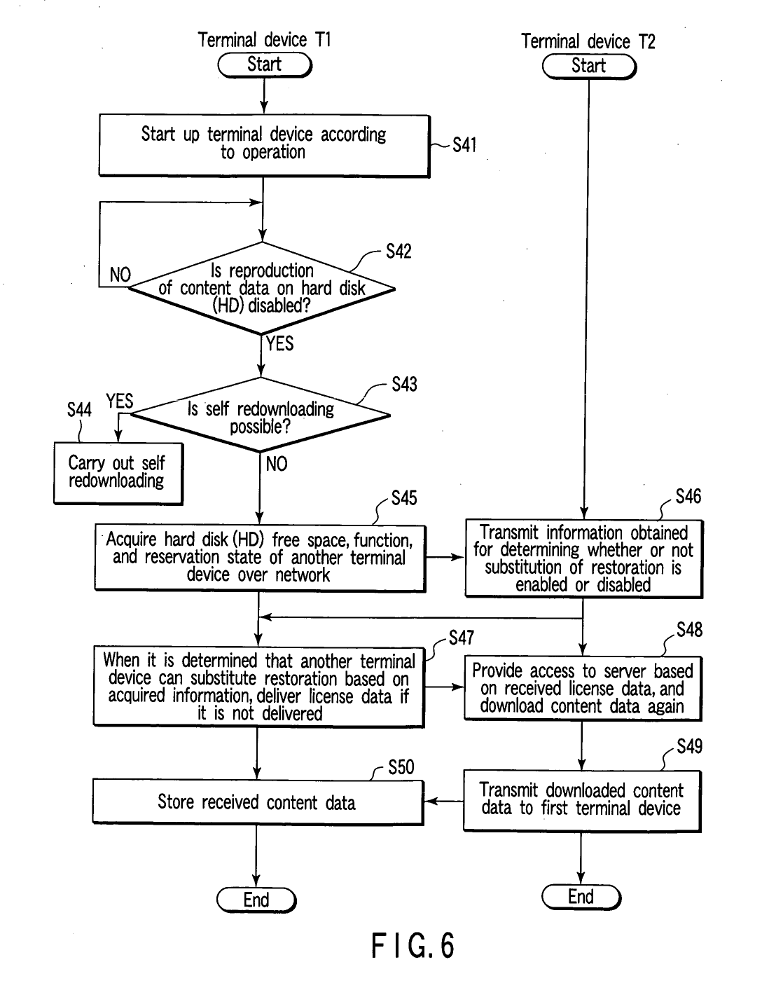

That is, in the recording and reproducing apparatus 10 according to the third embodiment, as shown in the flowchart of FIG. 6, power is supplied to each section of the recording and reproducing apparatus 10 according to an operation of turning on/off the user's power switch (S41). Here, it is determined whether or not each of all the items of content information on a hard disk (HD) can be reproduced (S42). If there exists content information which cannot be reproduced, it is determined whether or not other content information on the hard disk drive section 18 can be reproduced, whereby it is determined whether or not such content information can be restored by itself (S43). If there occurs no problem with a function of the network interface section 11 as well as a function of the hard disk drive section 18, content information is downloaded again in accordance with the procedures of step S12 in order to restore the content information by the recording and reproducing apparatus 10 itself (S44).

If there occurs a problem with a recording function of the hard disk drive section 18 or a communication function of the network Interface section 11 with the Internet or the like, a request signal for requesting transmission of information is transmitted to each of the terminal devices T2, T3, in order to cause the other terminal devices T2, T3 over the local network to substitute restoration of the content information and in order to collect information on free space and functions or reservation state of a hard disk section of such another terminal device (S45).

In response to this transmission, the terminal device T2 or the like over the local network transmits information required for determining whether or not to substitute restoration, for example, information on a hard disk free space, a communication function, a recording function, and a reservation image recording function (S46). Upon the receipt of these items of information, when it is determined that another terminal device can substitute restoration based on the collected information, the recording and reproducing apparatus 10 delivers license data L to the terminal devices T2, T3, if it has not been delivered yet (S47). Further, when it is determined that another terminal device can substitute restoration, decoding key data K is delivered and its own decoding key data is deleted.

In response to this deletion, the terminal device T2 or the like over the local network provides an access to the server S based on the received license data to download content information C again, as shown in FIG. 3 (S48). Then, the downloaded content data is transmitted to the first terminal device T1 (S49). The first terminal device T1 stores this content information in the hard disk drive section 18 or the like, and is ready for the user's reproduction command or the like (S50).

As has been described above in detail, in the above-described recording and reproducing apparatus, in the case where content information cannot be acquired by itself, for example, in the case where content information cannot be read out because the content information is destroyed or a hard disk is destroyed after a communication section has acquired the content information from a server which is an external device via a network (mainly the Internet) and has recorded the acquired information in a hard disk or the like, another terminal device (for example, a recording and reproducing apparatus) over a local network (such as LAN at home) or over a broadband network can substitute reacquisition of the content information from the server. The reacquired content information is decoded based on decoding key in another terminal device; the decoded information is returned to a first recording and reproducing apparatus as a stream signal; and the returned stream signal is reproduced in the recording and reproducing apparatus.

Although one skilled in the art can achieve the present invention according to a variety of embodiments described above, the present invention is not limited to the above-described embodiments.

1. A recording and reproducing apparatus comprising:
a communication section which acquires content information from an external device via a network;
a recording section which records in a storage region the content information acquired from the communication section; and
a control section which, after it has been detected that the content information stored in the recording section cannot be read out, when it is determined that the content information cannot be reacquired from the external device due to an occurrence of a failure with a function of the communication section or recording section, controls a command signal for causing a terminal device over a network to substitute acquisition of the content information so as to be transmitted to the terminal device via the communication section.

2. A recording and reproducing apparatus according to claim 1, wherein the communication section supplies identification information on a user who attempts to acquire the content information to the external device during acquisition of the content information, and acquires decoding key data for use in decoding when reproducing the content information and license data at the same time of acquiring the content information, and
the control section supplies the user identification information, the decoding key data, and the license data to the terminal device over the network when the control section causes the terminal device over the network to substitute reacquisition of the content information.

3. A recording and reproducing apparatus according to claim 1, further comprising:
a reproducing section which receives via the communication section a stream signal obtained when the reacquired content information has been decoded based on the decoding key data in the terminal device over the network, and then, outputs a reproduction signal based on the stream signal.

4. A recording and reproducing apparatus according to claim 1, wherein, after it has been detected that the content information stored in the recording section cannot be read out, when it is determined that the content information cannot be reacquired from the external device due to an occurrence of a failure with a function of the communication section or recording section, the control section transmits a request signal to the terminal device via the communication section in order to request the terminal device over the network to issue information for determining whether or not the external device can substitute reacquisition of the content information, and
after the information for determination has been acquired from the terminal device, when it is determined that the terminal device can substitute reacquisition of the content information, the control section controls decoding key data for use in decoding when reproducing the content information so as to be supplied to the terminal device.

5. A recording and reproducing apparatus according to claim 1, wherein, when the control section is commanded to substitute reacquisition of content information from another terminal device over the network, the control section provides an access to an external device over the network via the communication section in response to the commanding to carry out reacquisition of the content information.

6. A recording and reproducing apparatus according to claim 1, wherein, when the control section is commanded to substitute reacquisition of content information as well as supply of decoding key data from another terminal device over the network, the control section provides an access to an external device over the network via the communication section in response to the commanding; and when the acquired content information is decoded based on the decoding key data, thereby obtaining a stream signal, the control section controls the thus obtained stream signal so as to be transmitted to the another terminal device via the communication section.

7. A recording and reproducing apparatus according to claim 1, wherein, when the control section is requested from another terminal device over the network to issue information for determining whether or not the recording and reproducing apparatus can substitute reacquisition of content information, the control section controls the information so as to be supplied to the another terminal device over the network via the communication section.

8. A recording and reproducing apparatus according to claim 1, further comprising:
a reproducing section which generates and outputs a reproduction signal based on the content information, wherein,
when it is determined that the reproducing section functions, the control section controls the terminal device over the network to acquire the content information, to transfer a stream signal after converted based on the acquired information, and to carry out reproduction by the reproducing section based on the stream signal acquired via the communication section; and, when it is determined that a failure occurs with a function of the reproducing section, the control section controls the terminal device over the network to acquire the content information and reproduce the acquired information on the terminal device.

9. A recording and reproducing apparatus according to claim 1, wherein, when it is determined that a failure occurs with a function of the reproducing section, the control section generates and outputs a display signal for displaying that the control section causes the terminal device over the network to reproduce the content information.

10. A recording and reproducing apparatus according to claim 1, wherein, after the recording and reproducing apparatus has been powered on from an off state thereof, when it is determined whether or not the content information recorded earlier by the recording section is currently recorded in a state in which the content information can be reproduced, it is detected that the information cannot be reproduced, and it is determined that the content information cannot be reacquired from the external device due to an occurrence of a failure with a function of the communication section or recording section, the control section controls a command signal for causing the terminal device over the network to substitute reacquisition of the content information from the external device, via communication section, so as to be transmitted to the terminal device via the communication section.

11. A recording and reproducing method comprising:
acquiring content information from an external device via a network;
recording in a storage region the acquired content information; and
after it has been detected that the content information cannot be read out, when it is determined that the content information cannot be reacquired from the external device due to an occurrence of a failure with a communication function or a recording function of the recording and reproducing apparatus, controlling a command signal for causing a terminal device over the network to substitute acquisition of the content information from the external device due to the communication so as to be transmitted to the terminal device via the communication.

12. A recording and reproducing method according to claim 11, wherein, when the content information is acquired from the external device, identification information on a user who attempts to acquire the content information is supplied to the external device, and decoding key data for use in decoding when reproducing the content information and license data are acquired at the same time of acquiring the content information, and
the user identification information, the decoding key data, and the license data are supplied to the terminal device over the network when the terminal device over the network is caused to substitute reacquisition of the content information.

13. A recording and reproducing method according to claim 11, wherein the content information is required from the external device in the terminal device over the network, and upon receipt of a stream signal obtained when the reacquired content information has been decoded based on the decoding key data, a reproduction signal is outputted based on the stream signal.

14. A recording and reproducing method according to claim 11, wherein, after it has been detected that the stored content information cannot be read out, when it is determined that the content information cannot be reacquired from the external device due to an occurrence of a failure with the communication function or recording function, a request signal is transmitted to the terminal via the communication section in order to request the terminal device to issue information for determining whether or not the external device can substitute reacquisition of the content information, and
after the information for determination has been acquired from the terminal device, when it is determined that the terminal device can substitute reacquisition of the content information, decoding key data for use in decoding when reproducing the content information is controlled so as to be supplied to the terminal device.

15. A recording and reproducing method according to claim 11, wherein, when a command is issued to substitute reacquisition of content information from another terminal device over the network, an access is provided to the external device over the network due to the communication in response to the command to carry out reacquisition of the content information.

16. A recording and reproducing method according to claim 11, wherein, when a command is issued to substitute reacquisition of content information as well as supply of decoding key data from another terminal device over the network, an access is provided to the external device over the network in response to the command, and when the acquired content information is decoded based on the decoding key data, thereby obtaining a stream signal, the thus obtained stream signal is controlled so as to be transmitted to the another terminal device.

17. A recording and reproducing method according to claim 11, wherein, when another terminal device over the network requests to issue information for determining whether or not the recording and reproducing apparatus can substitute reacquisition of content information, the information is controlled so as to be supplied to the another terminal device over the network.

18. A recording and reproducing method according to claim 11, wherein, when it is determined that a reproducing function of the recording and reproducing apparatus which generates and outputs a reproduction signal based on the content information functions, the terminal device over the network is controlled to acquire the content information, to transfer a stream signal after converted based on the acquired information, and to carry out reproduction by the reproducing function based on the acquired stream signal, and wherein, when it is determined that a failure occurs with the reproducing function, the terminal device over the network is controlled to acquire the content information and reproduce the acquired information on the terminal device.

19. A recording and reproducing method according to claim 11, wherein, when it is determined that a failure occurs with the reproducing function, a display signal for displaying that the terminal device over the network is caused to reproduce the content information is generated and outputted.

20. A recording and reproducing method according to claim 11, wherein, after the recording and reproducing apparatus has been powered on from an off state thereof, when it is determined whether or not the content information recorded earlier in the storage region is currently recorded in a state in which the content information can be reproduced, it is detected that the information cannot be reproduced, and it is determined that the content information cannot be reacquired from the external device due to an occurrence of a failure with the communication function or recording function, a command signal for causing the terminal device over the network to substitute reacquisition of the content information from the external device is controlled so as to be transmitted to the terminal device.
